(19) United States
(12) Patent Application Publication
(10) Pub. No.: US 2008/0203829 A1
(43) Pub. Date: Aug. 28, 2008

(54) VIBRATING-TYPE MOTOR

(75) Inventors: Noboru MATSUMOTO, Hino City (JP); Keishi OHSHIMA, Miura City (JP); Yoshinori MIZOGUCHI, Chofu City (JP)

Correspondence Address: ROSSI, KIMMS & McDOWELL LLP., P.O. BOX 826, ASHBURN, VA, 20146-0826, US

(73) Assignee: FUJI ELECTRIC SYSTEMS CO., LTD., Tokyo (JP)

(21) Appl. No.: 12/035,038

(22) Filed: Feb. 21, 2008

(30) Foreign Application Priority Data
Feb. 21, 2007 (JP) 2007-040998
Sep. 5, 2007 (JP) 2007-230172

(51) Int. Cl. H02K 33/00

(52) U.S. Cl. 310/15

(57) ABSTRACT

A vibrating-type motor is provided, in which only a restoring force is reduced without reducing a thrust increasing effect by auxiliary magnets, thereby reducing size while increasing efficiency. Specifically, a vibrating-type motor is provided that includes a moving part having a main magnet and auxiliary magnets individually junctioned coaxially to axial end portions of the main magnet at junction locations, an exciting yoke including two leg portions opposed to the moving part through a gap, and arranged with respect to the moving part such that a first distance between central portions of faces of the two leg portions that are closest to the moving part is different from a second distance between the junction locations, an exciting coil wound on the exciting yoke for generating a magnetic flux in the leg portions, and a back yoke arranged to confront the exciting yoke with the moving part located between the back yoke and the exciting yoke, wherein the axial end portions of the moving part are substantially coincident with outer-side end portions of the faces of the leg portions.

### BACKGROUND

The present invention relates to a vibrating-type motor, which can be used, for example, in a vibrating-type compressor for a Stirling freezer.

A moving-magnet type linear motor (hereinafter simply referred to as a “moving-magnet type motor”) has conventionally been employed as a vibrating-type motor. FIGS. 4 and 5 are schematic diagrams that explain a driving principle of a moving-magnet type motor, and show portions of a section taken along a center axis C of a substantially cylindrical motor. As shown in FIG. 4, the motor includes an exciting yoke 101, an exciting coil 102, a back yoke 103, and a moving part 104. The moving part 104 is made of a cylindrical permanent magnet arranged in a gap portion between the exciting yoke 101 and the back yoke 103 and magnetized with different poles on the inner circumference side and the outer circumference side. A magnetic flux 201 generated by the moving part 104 is also illustrated. A conventional casing for supporting the moving part 104 is provided but not illustrated.

In most moving-magnet type motors as shown, a single permanent magnet having a magnetized single pole is used as the moving part 104, which is integrally connected to a piston (not shown). The moving part 104 has its two axial end portions confined within the leg width of the exciting yoke 101. In a case where the moving part 104 has its outer circumference magnetized to the N-pole and its inner circumference side magnetized to the S-pole, as shown in FIG. 4, the magnetic flux 201 generated from the outer circumference side returns around the outer side of the moving part 104 to the inner circumference side. In the two axial end portions of the moving part 104, therefore, the aforementioned magnetic flux 201 becomes equivalent to that which would be generated if the electric currents were fed opposite to that of the direction normal to the drawing. This magnetic flux is called the equivalent current I_{M} of the permanent magnet.

When a magnetic flux Φ is generated by feeding an AC current to the exciting coil 102 and when this flux Φ is linked to a gap G, in which the equivalent current I_{M} exists, as shown in FIG. 5, the moving part 104 arranged in the gap G is reciprocated according to Fleming's lefthand rule by the force (thrust) in the lateral direction of the drawing. The aforementioned thrust F can be simply calculated according to following Formula 1:

F=B·2IM·LM,

wherein letter B designates a magnetic flux density of the magnetic flux Φ generated in the gap G, and L_{M} designates an average length in the circumferential direction of the moving part 104. In Formula 1, the equivalent current I_{M} is doubled unlike the ordinary B·I·L rule, because the equivalent I_{M} exists in this model at two portions of the two axial end portions of the moving part 104.

On the other hand, the moving part 104 is provided with a mechanical spring (e.g., a coil spring or a leaf spring) having a proper spring force in the not-shown axial direction (as shown in JP-A-2005-9397). This is because the input power can be suppressed by driving the moving part 104 at the resonance point of the mechanical vibrations. Generally, a Stirling freezer is run at a relatively low frequency of 40 to 80 Hz. The natural frequency f of a simple spring-mass system is given for a spring constant k and a mobile mass m by the following Formula 2:

f=½π√k/m.

In a case where the vibrating-type motor of the invention is used as a compressor, moreover, the spring constant k is expressed, by the following Formula 3:

k=kₛₚ+k_{mag}+k_{gas},

wherein:

kₛₚ designates a spring constant by the mechanical spring;

k_{mag} designates a spring constant by the restoring force of the moving part magnet; and

k_{gas} designates a spring constant by a compressed gas.

Of these, the spring constant k_{gas} is substantially determined by the filling pressure and the compression ratio of the compressed gas in accordance with the freezing output required, so that it is difficult to intentionally adjust. In case the moving part 104 is a single permanent magnet having a magnetized single pole, as shown in FIG. 4 and FIG. 5, the restoring force of the magnet hardly acts in the moving range, so that no practical consideration is needed for the constant k_{mag}. As a result, the mechanical spring constant kₛₚ has a wide adjustable range so that it is relative easy to design.

In addition, in order that the thrust F may be increased without changing the body of the motor (L_{M}=constant), the magnetic flux density B or the equivalent current I_{M} of the gap may be increased, as apparent from Formula 1. At first, in order to increase the magnetic flux density B, it is necessary to decrease the gap length of the gap or to increase the exciting current to flow through the exciting coil 102. However, the former method has a problem that the moving part 104 and its supporting member are made thin, which can easily result in a reduction in strength and a rise in manufacturing costs, and the latter method has a problem that a Joule's heat loss (I²R) is increased thereby inviting a drop in performance.

In order to increase the equivalent current I_{M}, on the other hand, it is possible not only to change the thickness of the permanent magnet as the moving part 104 but also to use a permanent magnet having a stronger magnetic force. However, both of these options would raise manufacturing expenses.

Another method for increasing the thrust F is shown in FIG. 6. In this example of a moving-magnet type motor, cylindrical auxiliary magnets 106 and 107, which are magnetized in the opposite direction to the main magnet 105, are coaxially and integrally junctioned to the two axial end portions of a cylindrical main magnet 105 so that a moving part 104A is formed to virtually increase the equivalent current I_{M} U.S. Pat. Nos. 5,148,066 and 4,937,481, for example, illustrate that it is well known to include a moving part having a main magnet and a pair of auxiliary magnets. In the example illustrated in FIG. 6, the magnetic fluxes cancel each other in the unexcited state at the junction portions between the main magnet 105 and the auxiliary magnets 106 and 107 so that the retentiveness at the neutral position of the moving part 104A is made stronger than that of the structure of FIG. 4 and FIG. 10. This results in an advantage in that so-called “self-centering” is facilitated.

FIG. 7 is a schematic diagram of the moving-magnet type motor described in U.S. Pat. No. 5,148,066. The motor illustrated in FIG. 7 includes a back yoke 201, an exciting coil 202, an exciting yoke 203, a moving part 204, a main magnet 205, and auxiliary magnets 206 and 207. The motor is coupled to a Stirling engine 300 located within a casing 301 via a piston 302. A displacer 303 is also located within the casing 301. A neutral position 210 is designated for the moving part 204. In a case where the moving part 204 is displaced in the axial direction, according to the prior art shown in FIG. 7, a strong restoring force acts on the moving part 204. As a result, a piston stroke may be unable to be sufficiently retained.

As a countermeasure for relaxing the aforementioned restoring force, it is disclosed in FIGS. 7A and 8A in U.S. Pat. No. 5,148,066 that the shape and structure are changed by a method of forming the auxiliary magnets into a triangular shape or thinning the same. In order to design those shapes and so on to the optimum values, the parameters are so increased that it is difficult to design the auxiliary magnets. If the method of making the auxiliary magnets triangular or the like is adopted, moreover, the equivalent current is decreased and raises a problem that not only the restoring force but also the thrust increasing effect is lowered.

On the other hand, in case no countermeasure is taken for relaxing the restoring force, the strong restoring force acts on the main magnet and the auxiliary magnets. This makes it necessary to consider the constant k_{mag}, as expressed by Formula 3. As the constant k_{mag} increases, it is apparent from Formula 2 and Formula 3 that the range required for designing the mechanical spring to adjust the resonation of the mechanical vibrations is narrowed to make the design of a low-frequency resonation difficult.

In this case, it is also conceivable to reduce the radial retentiveness of the support spring (or the mechanical spring) to thereby weaken the entire spring force, or to increase the mobile mass in Formula 2. However, these countermeasures still have problems in that the piston and the cylinder cannot be supported in a non-contact manner, and that the entire structure is heavy and large.

In view of the above, it would be desirable to provide a vibrating-type motor, in which only a restoring force is reduced without reducing a thrust increasing effect by auxiliary magnets, thereby reducing size while increasing efficiency.

### SUMMARY OF THE INVENTION

The invention provides a vibrating-type motor, in which only a restoring force is reduced without reducing a thrust increasing effect by auxiliary magnets, thereby reducing size while increasing efficiency. Specifically, a vibrating-type motor is provided that includes a moving part having a main magnet and auxiliary magnets individually junctioned coaxially to axial end portions of the main magnet at junction locations, an exciting yoke including two leg portions opposed to the moving part through a gap, and arranged with respect to the moving part such that a first distance between central portions of faces of the two leg portions that are closest to the moving part is different from a second distance between the junction locations, an exciting coil wound on the exciting yoke for generating a magnetic flux in the leg portions, and a back yoke arranged to confront the exciting yoke with the moving part located between the back yoke and the exciting yoke, wherein the axial end portions of the moving part are substantially coincident with outer-side end portions of the faces of the leg portions.

The exciting yoke is disposed on the radially outer side of the moving part and the back yoke is disposed on the radially inner side of the moving part. Alternatively, the exciting yoke is disposed on the radially inner side of the moving part and the back yoke is disposed on the radially outer side of the moving part.

In one preferred embodiment, the second distance between the junction locations is larger than the first distance between central portions of faces of the two leg portions that are closest to the moving part, and an axial length of the moving part is larger than the first distance.

According to the invention, it is possible to provide a vibrating-type motor, which can relax the restoring force due to the permanent magnet of the moving part while substantially keeping the thrust, as might otherwise be caused by the exciting current, of the moving part, and which can be small in size, light in weight, and low in price.

Other features and advantages of the invention will become apparent from the following detailed description of the preferred embodiments of the invention.

### BRIEF DESCRIPTION OF THE DRAWINGS

The invention will be described with reference to certain preferred embodiments thereof and the accompanying drawings, wherein:

FIG. 1 is a schematic diagram showing a vibrating-type motor in accordance with the invention;

FIG. 2 is a diagram showing the relationship between the displacement and the restoring force of the moving part in a case where the positional relationship between the central portions of the leg portions and the junction portions of the moving part are shifted;

FIG. 3 is a diagram showing relations between the displacement and the net thrust of the moving part of the embodiment in case the positional relations between the central portions 11b and 12b of the junction portions and the leg portions of the moving part are shifted;

FIG. 4 is a schematic diagram for explaining a driving principle of conventional a moving-magnet type motor;

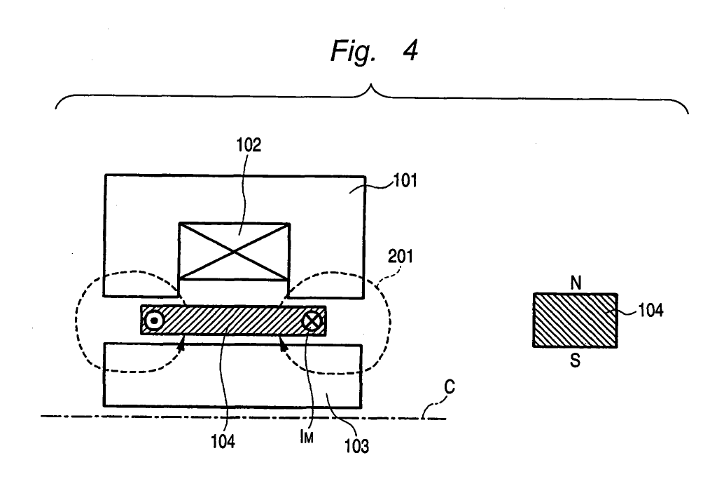

FIG. 5 is a schematic diagram for explaining a driving principle of a conventional moving-magnet type motor;

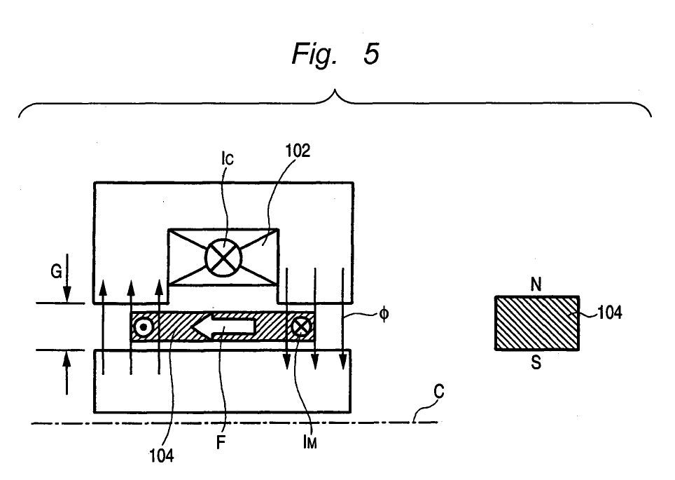

FIG. 6 is a schematic diagram showing a conventional motor structure; and

FIG. 7 is a schematic diagram showing a conventional motor structure.

### DETAILED DESCRIPTION OF THE PREFERRED EMBODIMENTS OF THE INVENTION

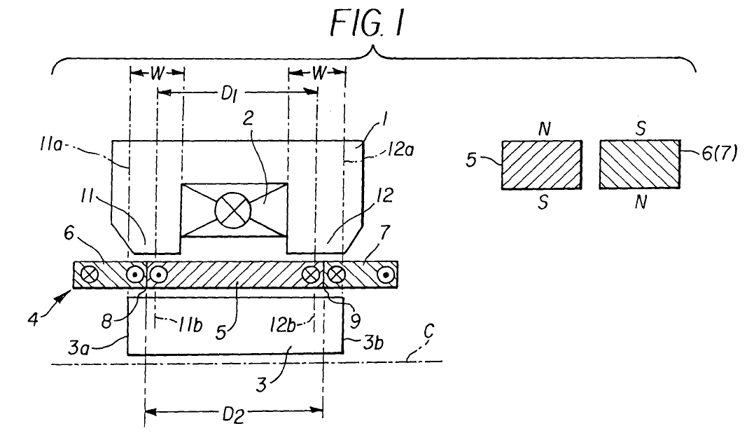

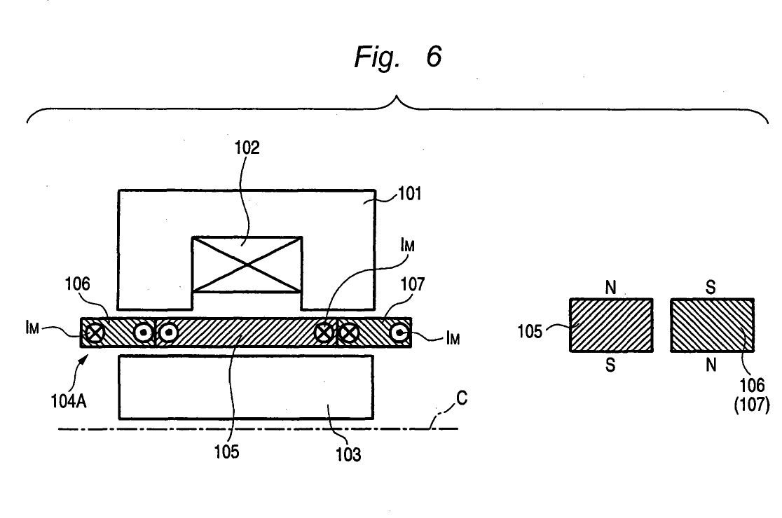

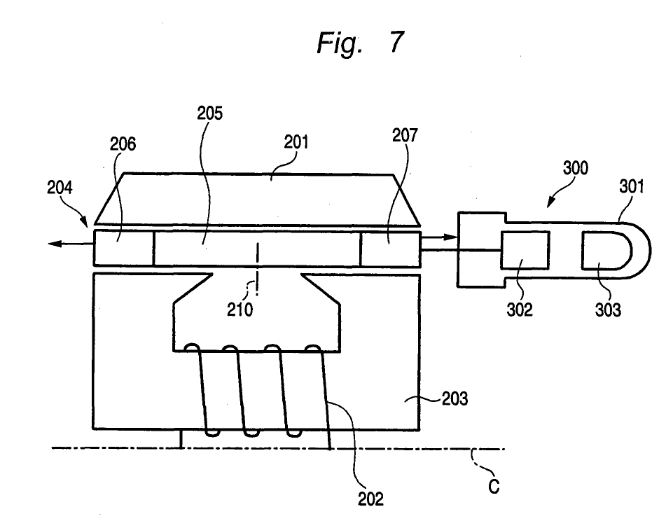

FIG. 1 is a schematic diagram illustrating a vibrating-type motor in accordance with the invention. As in FIGS. 6 to 9 discussed above, FIG. 1 illustrates a portion of a section taken along a center axis C of a substantially cylindrical motor. FIG. 1 illustrates a motor that includes an exciting yoke 1, an exciting coil 2 wound on the exciting yoke 1, a back yoke 3, and a moving part 4. The moving part 4 is made of a permanent magnet arranged in the gap portion between the exciting yoke 1 and the back yoke 3. A conventional casing for supporting the moving part 4 is not shown in the drawing.

As shown in FIG. 1, the moving part 4 is constructed by connecting auxiliary magnets 6 and 7 coaxially and integrally to the two axial end portions of main magnet 5 at junction locations 8, 9, wherein the main magnet 5 has its outer circumference side to the N-pole and its inner circumference side to the S-pole. The auxiliary magnets 6 and 7 are magnetized in the direction opposite to that of the main magnet 5. The main magnet 5 and the auxiliary magnets 6 and 7 are preferably composed of a rare earth element such as neodymium or samarium.

The exciting yoke 1 is formed by laminating a plurality of sheets such as iron sheets or silicon steel sheets. In a case in which an alternating magnetic field is applied, as in a vibrating-type motor, the exciting yoke 1 is preferably insulated in a direction perpendicular to the magnetic flux by using the laminated steel sheets or the like, because eddy currents perpendicular to the magnetic flux are established that deteriorate performance.

As shown in FIG. 1, central portions 11b and 12b of faces 11f and 12f of the leg portions 11 and 12 that are located closest to the moving part have widths W. The end portions 3a and 3b of the back yoke 3 substantially coincide with the outer-side end portions 11a and 12a of the faces 11f and 12f of the leg portions 11 and 12 that are closest to the moving part 4. In short, the axial length of the back yoke 3 is equal to the distance between the outer-side end portions 11a and 12a. In addition, the junction positions 8 and 9 and the central portions 11b and 12b of the leg portions 11 and 12 are displaced in the axial direction with respect to each other. From another perspective, a distance between the junction positions 8 and 9 and a distance between the central portions 11b and 12b are different from one another.

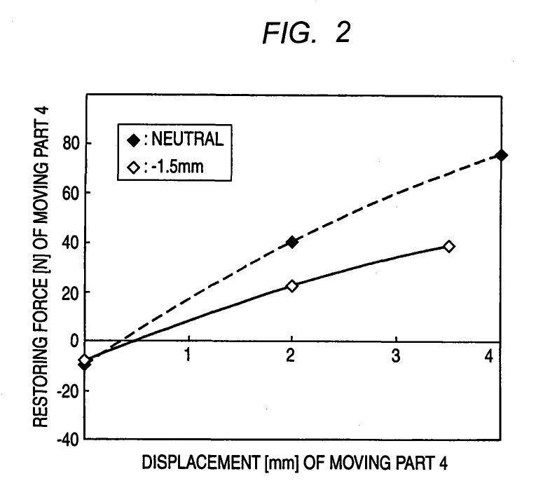

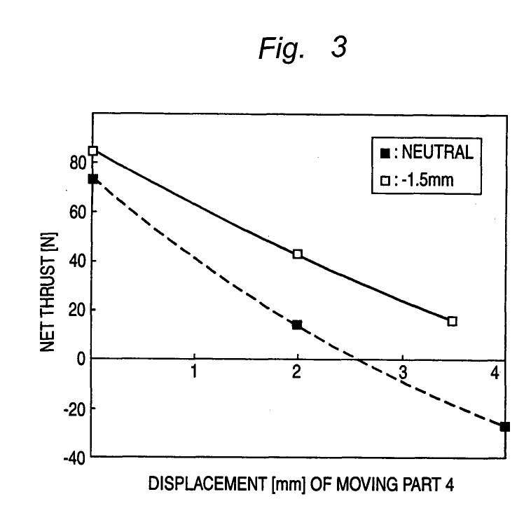

FIG. 2 shows the relationship between the displacement of the moving part 4 and the restoring force of the cases (Neutral in FIG. 2), in which the positions of the central portions 11b and 12b of the leg portions 11 and 12 of the exciting yoke 1 are made coincident with the junction position 8 and 9 and are shifted by 1.5 mm to the inner side. FIG. 3 shows, like FIG. 2, the relationship between the displacement of the moving part 4 and the net thrust of the cases (Neutral in FIG. 3), in which the positions of the central portions 11b and 12b of the leg portions 11 and 12 of the exciting yoke 1 are made coincident with the junction positions 8 and 9 and are shifted by 1.5 mm to the inner side.

In a case where the auxiliary magnets 6 and 7 are present, it is understood, from FIG. 2, that the restoring force steadily increases as the moving part 4 moves. At the same time, as shown in FIG. 3, the net thrust steadily decreases as the moving part 4 moves. The net thrust implies the total force, which is composed of the force generated at the moving part 4 by the exciting current and the restoring force. In the case of “Neutral” in FIG. 2 and FIG. 3, it is understood from the gradients of the curves that the restoring force is very strong, and that the net thrust extremely decreases. In short, the “Neutral” case implies that the moving range of the moving part 4 is narrow.

In a case where the positions of the central portions 11b and 12b are shifted inward by 1.5 mm, on the other hand, the gradients of the curves of both the restoring force and the net thrust are gentler than those of the neutral state. In short, the restoring force by the moving part 4 can be relaxed, and the net thrust is strong and is reduced in its decreasing degree. Specifically, the positions of the central portions 11b and 12b are shifted to the inner side along the axial direction with respect to the junction positions 8 and 9. It is understood that the moving part 4 can be driven over a wide range without deteriorating the thrust increasing effect resulting from the mounting of the auxiliary magnets 6 and 7, although the thickness and shape of the auxiliary magnets 6 and 7 are under the same conditions as those of the neutral state.

The lengths of the auxiliary magnets 6 and 7 along the axial direction are set such that the two end portions of the moving part 4 may not overlap the faces 11f and 12f of the leg portions 11 and 12 that are closest to the moving part 4 even when the moving part 4 is displaced by the maximum length required as the motor stroke. This is because a reaction force is generated by an equivalent current (as referred to FIG. 6) existing at the outer-side end portions of the auxiliary magnets 6 and 7, in case the auxiliary magnets 6 and 7 are short, thereby to lower the thrust increasing effect.

The invention has been described with reference to certain preferred embodiments thereof. It will be understood, however, that modifications and variations are possible within the scope of the appended claims. For example, in the illustrated embodiments, the exciting yoke 1 is arranged on the radially outer side of the moving part 4, and the back yoke 3 is arranged on the radially inner side of the moving part 4. However, the arrangements of the exciting yoke 1 and the back yoke 3 may be reversed. Moreover, the vibrating-type motor according to the invention can be applied to a vibrating-type compressor or the like of a Stirling freezer.

This application claims priority from Japanese Patent Application No. 2007-040998 filed Feb. 21, 2007 and Japanese Patent Application No. 2007-230172 filed Sep. 5, 2007, the content of which is incorporated herein by reference.

What is claimed is:

1. A vibrating-type motor comprising:
a moving part including a main magnet and auxiliary magnets individually junctioned coaxially to axial end portions of the main magnet at junction locations;
an exciting yoke including two leg portions opposed to the moving part through a gap, and arranged with respect to the moving part such that a first distance between central portions of faces of the two leg portions that are closest to the moving part is different from a second distance between the junction locations;
an exciting coil wound on the exciting yoke for generating a magnetic flux in the leg portions; and
a back yoke arranged to confront the exciting yoke with the moving part located between the back yoke and the exciting yoke;
wherein the axial end portions of the moving part are substantially coincident with outer-side end portions of the faces of the leg portions.

2. A vibrating-type motor according to claim 1, wherein said exciting yoke is disposed on the radially outer side of said moving part, and wherein said back yoke is disposed on the radially inner side of said moving part.

3. A vibrating-type motor according to claim 1, wherein said exciting yoke is disposed on the radially inner side of said moving part, and wherein said back yoke is disposed on the radially outer side of said moving part.

4. A vibrating-type motor according to claim 1, wherein the second distance is larger than the first distance.

5. A vibrating-type motor according to claim 1, wherein an axial length of the moving part is larger than the first distance.
